(19) United States
(12) Patent Application Publication
(10) Pub. No.: US 2025/0392178 A1
(43) Pub. Date: Dec. 25, 2025

(54) MOTOR AND CLOTHES TREATING APPARATUS

(71) Applicant: SAMSUNG ELECTRONICS CO., LTD., Suwon-si (KR)

(72) Inventors: Donggyu SEONG, Suwon-si (KR); Eunsuk KO, Suwon-si (KR); Unyong LEE, Suwon-si (KR); Jongjin LEE, Suwon-si, (KR); Jinki LEE, Suwon-si (KR)

(73) Assignee: SAMSUNG ELECTRONICS CO., LTD., Suwon-si (KR)

(21) Appl. No.: 19/193,371

(22) Filed: Apr. 29, 2025

Related U.S. Application Data
(63) Continuation of application No. PCT/KR2025/005347, filed on Apr. 21, 2025.

(30) Foreign Application Priority Data
Jun. 24, 2024 (KR) 10-2024-0081929

(51) Int. Cl. H02K 1/279; D06F 37/30

(52) U.S. Cl. CPC H02K 1/279; D06F 37/30

(57) ABSTRACT

A motor includes a stator and a rotor. The rotor may include a holder including a base and a sidewall extending from an edge of the base, a rotor body including a plurality of rotor cores and a plurality of magnets and disposed inside the sidewall of the holder, and a frame disposed inside the base of the holder.

### CROSS REFERENCE TO THE RELATED APPLICATION

This application is a continuation application, filed under 35 U.S.C. § 111(a), of International Application PCT/KR2025/005347 filed Apr. 21, 2025, and is based on and claims priority under 35 U.S.C. § 119 to Korean Patent Applications No. 10-2024-0081929, filed on Jun. 24, 2024, in the Korean Intellectual Property Office, the disclosures of which are incorporated by reference herein in their entireties.

### TECHNICAL FIELD

The disclosure relates to a motor and a clothes treating apparatus.

### BACKGROUND ART

A clothes treating apparatus is an apparatus for treating and/or caring clothes. The clothes treating apparatus may include a washing machine and/or a dryer.

A washing machine is a device for agitating laundry, water, and detergent together to achieve washing through mutual friction. The processes performed by a washing machine, regardless of the type of washing machine, may include a washing process in which detergent and water are supplied to a tub and the a drum is rotated to wash laundry, a rinsing process in which water is supplied to the tub and the drum is rotated to rinse the laundry, and a spin-drying process in which water is discharged from the tub and the drum is rotated to remove moisture from the laundry.

A dryer is a device for drying an object with hot dry air. A dryer may dry an object by rotating a drum in which the object is received while allowing hot air to pass through the drum. A process performed by the dryer may include a drying process for drying the object.

### SUMMARY

An embodiment of the present disclosure provides a motor having an improved structure and a clothes treating apparatus including the same.

An embodiment of the present disclosure provides a motor having a rotor with reduced and/or prevented deformation (e.g., shrinkage), damage, and the like, and a clothes treating apparatus including the same.

An embodiment of the present disclosure provides a motor having a rotor with increased rigidity and a clothes treating apparatus including the same.

An embodiment of the present disclosure provides a motor with improved process efficiency and reduced manufacturing cost, and a clothes treating apparatus including the same.

Technical tasks to be achieved in this document are not limited to the technical tasks mentioned above, and other technical tasks not mentioned will be clearly understood by those skilled in the art from the description below.

A motor according to an embodiment of the present disclosure may include a stator and a rotor configured to rotate relative to the stator and outside the stator. The rotor may include a holder configured to accommodate the stator, the holder including a base configured to cover one side of the stator and a sidewall extending from an edge of the base and configured to surround the stator, a rotor body disposed inside the sidewall, the rotor including a plurality of rotor cores and a plurality of magnets and configured so that each of the plurality of rotor cores and each of the plurality of magnets are arranged alternately, and a frame disposed inside the base to support the edge of the base connected to the sidewall.

A clothes treating apparatus according to an embodiment of the present disclosure may include a tub, a drum rotatable in the tub, a motor configured to generate a driving force, the motor including a stator and a rotor configured to rotate in interaction with the stator, and a rotating shaft configured to connect the motor and the drum to transmit the driving force of the motor to the drum. The rotor may include a rotor body including a plurality of rotor cores and a plurality of magnets. Each rotor core and each magnet of the rotor body may be configured to be alternately arranged along a rotational direction of the rotor. The rotor body may have an annular shape. The rotor may include a frame spaced apart from the rotor body and having a circular shape. The rotor may include a holder integrally formed with the rotor body and the frame by insert injection. The holder may include a first molded portion corresponding to the rotor body. The holder may include a second molded portion extending from the first molded portion and corresponding to the frame.

### DESCRIPTION OF DRAWINGS

FIG. 1 is a cross-sectional view of an example of a clothes treating apparatus according to an embodiment.

FIG. 2 is a cross-sectional view of an example of a clothes treating apparatus according to an embodiment.

FIG. 3 illustrates a motor according to an embodiment.

FIG. 4 is a perspective view of the rotor according to an embodiment.

FIG. 5 is a cutaway perspective view taken along line A-A′ shown in FIG. 4.

FIG. 6 is a perspective view of some configurations of the rotor according to an embodiment.

FIG. 7 is a perspective view of some configurations of the rotor according to an embodiment in a different direction from FIG. 6.

FIG. 8 is an exploded view of some configurations of the rotor according to an embodiment.

FIG. 9 is an exploded view of some configurations of the rotor according to an embodiment in a different direction from FIG. 8.

FIG. 10 illustrates an interior of the rotor according to an embodiment.

FIG. 11 is a cross-sectional view taken along line B-B′ shown in FIG. 10.

FIG. 12 is an enlarged view of portion C shown in FIG. 11.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub disposed within the housing to store water. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, various embodiments according to the disclosure will be described in detail with reference to the accompanying drawings.

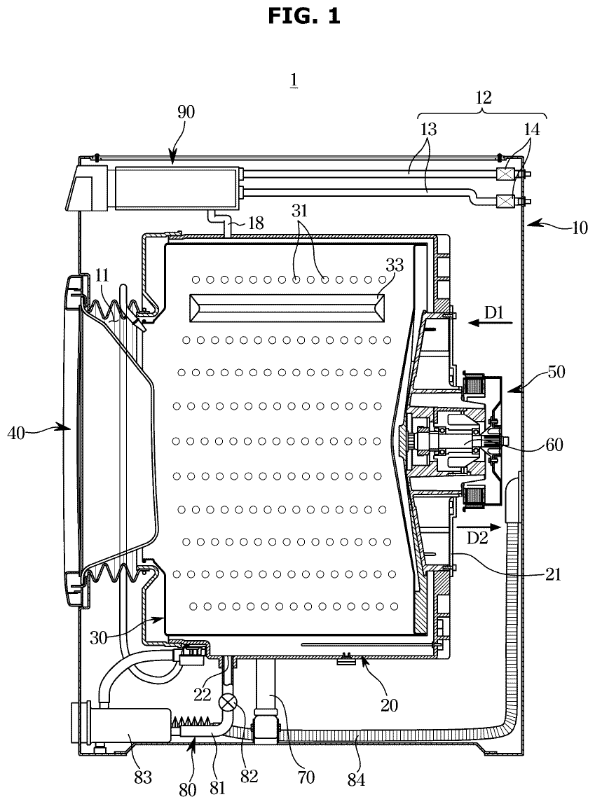

FIG. 1 is a cross-sectional view of an example of a clothes treating apparatus according to an embodiment. With reference to FIG. 1, a washing machine 1 will be described as an example of a clothes treating apparatus. The washing machine 1 may correspond to a front-loading washing machine.

As shown in FIG. 1, the washing machine 1 may include a housing 10, a tub 20 arranged inside the housing 10, and a drum 30 arranged inside the tub 20. The washing machine 1 may include a motor 50 configured to rotate the drum 30.

The washing machine 1 may include the housing 10 configured to accommodate various configurations therein. The housing 10 may form an exterior of the washing machine 1. The housing 10 may have a box shape with a portion open.

The washing machine 1 may include an inlet 11 formed to be accessible to an interior of the drum 30. Laundry may be placed in the drum 30 or removed from the drum 30 through the inlet 11. The inlet 11 may be open substantially forwardly. For example, the inlet 11 may include an opening formed in the housing 10, an opening formed in the tub 20, and an opening formed in the drum 30.

The washing machine 1 may include a door 40 for opening or closing the inlet 11. The door 40 may be rotatably mounted to the housing 10 by a hinge. At least a portion of the door 40 may be transparent or translucent to allow the interior of the housing 10 to be visible.

The washing machine 1 may include the tub 20 arranged inside the housing 10 to store water. The tub 20 may be arranged in the inside of the housing 10. The tub 20 may be supported inside the housing 10. The tub 20 may have a substantially cylindrical shape with one side open.

The tub 20 may be resiliently supported from the housing 10 by a damper 70. The damper 70 may connect the housing 10 and the tub 20. The damper 70 may be configured to absorb vibration energy between the tub 20 and the housing 10 when vibrations generated during rotation of the drum 30 are transmitted to the tub 20 and/or the housing 10, thereby damping the vibrations.

The washing machine 1 may include the drum 30 configured to receive laundry. The drum 30 may be rotatably arranged inside the tub 20. The drum 30 may perform washing, rinsing, spin-drying, and/or drying while rotating within the tub 20. The drum 30 may include a through-hole 31 connecting an internal space of the drum 30 and an internal space of the tub 20. The drum 30 may have a substantially cylindrical shape with one side open. At least one lifter 33 may be installed on an inner circumferential surface of the drum 30 to allow the laundry to be raised and lowered as the drum 30 rotates.

The washing machine 1 may include a driving device for driving the drum 30. The driving device may rotate the drum 30. The driving device may be configured to rotate the drum 30 in a forward or backward direction to perform washing, rinsing, and/or spin-drying, or drying operations.

The driving device may include the motor 50 that generates a driving force. The motor 50 will be described in more detail later.

The driving device may include a rotating shaft 60 for transmitting the driving force generated by the motor 50 to the drum 30. The rotating shaft 60 may connect the drum 30 and the motor 50. One end of the rotating shaft 60 may be connected to the drum 30, and the other end of the rotating shaft 60 may be connected to the motor 50.

A bearing housing 21 may be arranged on a rear portion of the tub 20 to rotatably support the rotating shaft 60. For example, the bearing housing 21 may be made of an aluminum alloy and may be inserted into the rear portion of the tub 20 when the tub 20 is injection molded.

The washing machine 1 may include a water supply device 12. The water supply device 12 may supply water to the tub 20. The water supply device 12 may be positioned on an upper side of the tub 20. The water supply device 12 may include a water supply pipe 13 and a water supply valve 14 arranged in the water supply pipe 13. The water supply pipe 13 may be connected to an external water source. The water supply pipe 13 may extend from the external water source to a detergent supply device 90 and/or the tub 20. Water may be supplied to the tub 20 via the detergent supply device 90. Water may be supplied to the tub 20 without passing through the detergent supply device 90.

The water supply valve 14 may open or close the water supply pipe 13 in response to an electrical signal from a controller. The water supply valve 14 may allow or block the supply of water from the external water source to the tub 20. The water supply valve 14 may include, for example, a solenoid valve that opens and closes in response to an electrical signal.

The washing machine 1 may include the detergent supply device 90 configured to supply detergent to the tub 20. The detergent supply device 90 may be configured to supply detergent into the tub 20 during a water supply process. Water supplied through the water supply pipe 13 may be mixed with detergent via the detergent supply device 90. The water mixed with detergent may be supplied to the interior of the tub 20. The detergent may include laundry detergent, as well as fabric softener (i.e., dryer rinse), a deodorizer, a sanitizer, an air freshener, and the like. The detergent supply device 90 may be connected to the tub 20 via a supply line 18.

The washing machine 1 may include a drainage device 80. The drainage device 80 may be configured to discharge water received in the tub 20 to the outside. The drainage device 80 may include a drainage pump 83 for pumping water from the tub 20. The drainage device 80 may include a connecting hose 81 connecting a drainage outlet 22 of the tub 20 and the drainage pump 83 such that water in the tub 20 may flow into the drainage pump 83. The drainage device 80 may include a drainage hose 84 that guides the water pumped by the drainage pump 83 to the outside of the housing 10. The drainage device 80 may include a drain valve 82 arranged on the connecting hose 81 to open and close the connecting hose 81.

The washing machine 1 may provide a user interface device for interaction between a user and the washing machine 1. The user interface device may include at least one input interface and at least one output interface.

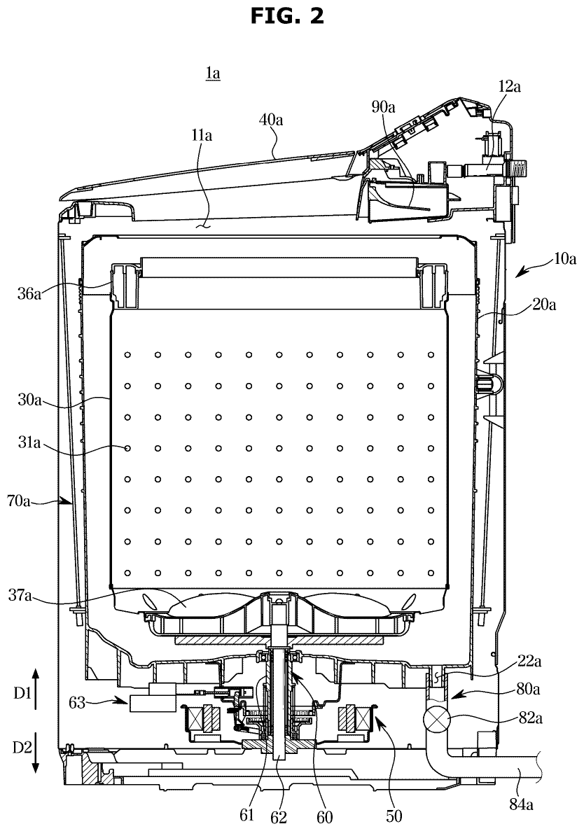

FIG. 2 is a cross-sectional view of an example of the clothes treating apparatus according to an embodiment. With reference to FIG. 2, a washing machine 1a, which is an example of a clothes treating apparatus, will be described. The washing machine 1a may correspond to a top-loading washing machine.

As shown in FIG. 2, the washing machine 1a may include a housing 10a, a tub 20a arranged inside the housing 10a, and a drum 30a arranged inside the tub 20a. The washing machine 1a may include the motor 50 configured to rotate the drum 30a.

The washing machine 1a may include the housing 10a configured to accommodate various configurations therein. The housing 10a may form an exterior of the washing machine 1a. The housing 10a may have a box shape that is partially open.

The washing machine 1a may include an inlet 11a formed to be accessible to an interior of the drum 30a. Laundry may be put into the drum 30a or taken out of the drum 30a through the inlet 11a. The inlet 11a may be open substantially upwardly. For example, the inlet 11a may include an opening formed in the housing 10a, an opening formed in the tub 20a, and an opening formed in the drum 30a.

The washing machine 1a may include the door 40a for opening or closing the inlet 11a. The door 40a may be rotatably mounted to the housing 10a by a hinge. At least a portion of the door 40a may be transparent or translucent to allow the inside of the housing 10a to be seen.

The washing machine 1a may include the tub 20a arranged inside the housing 10a to store water. The tub 20a may be arranged inside the housing 10a. The tub 20a may be supported inside the housing 10a. The tub 20a may have a substantially cylindrical shape with one side open.

The tub 20a may be resiliently supported from the housing 10a by a damper 70a. The damper 70a may connect the housing 10a and the tub 20a. The damper 70a may be configured to absorb vibration energy between the tub 20a and the housing 10a when vibrations generated during rotation of the drum 30a are transmitted to the tub 20a and/or the housing 10a, thereby damping the vibrations.

The washing machine 1a may include the drum 30a configured to accommodate laundry. The drum 30a may be rotatably arranged inside the tub 20a. The drum 30a may perform washing, rinsing, spin-drying, and/or drying while rotating inside the tub 20a. The drum 30a may include a through-hole 31a connecting an internal space of the drum 30a and an internal space of the tub 20a. The drum 30a may have a substantially cylindrical shape with one side open.

A balancing unit 36a may be installed on an upper portion of the drum 30a to eliminate the load imbalance caused by laundry. The balancing unit 36a may include a housing having an annular channel, and a mass body of balls or fluid movably provided inside the channel, and the balls or fluid may move according to the rotation of the drum 30a to eliminate the load imbalance of the drum 30a.

A pulsator 37a may be rotatably arranged on a lower portion of the drum 30a to generate a water current. Laundry may be washed by the water current generated by the pulsator 37a.

The washing machine 1a may include a driving device for driving the drum 30a and the pulsator 37a. The driving device may be configured to rotate the drum 30a. The driving device may be configured to rotate the pulsator 37a.

The driving device may include the motor 50 that generates a driving force. The motor 50 will be described in more detail later.

The driving device may include the rotating shaft 60 for transmitting the driving force generated by the motor 50 to the drum 30a and the pulsator 37a. The rotating shaft 60 may connect the drum 30a and the motor 50.

For example, the rotating shaft 60 may include a spin-drying shaft 61 configured to transmit the driving force of the motor 50 to the drum 30a. The rotating shaft 60 may include a washing shaft 62 configured to transmit the driving force of the motor 50 to the pulsator 37a. The spin-drying shaft 61 may be formed to have a hollow, and the washing shaft 62 may be arranged in the hollow of the spin-drying shaft 61.

The washing machine 1a may include a clutch device 63 for connecting or disconnecting the motor 50 and the spin-drying shaft 61. In response to the clutch device 63 disconnecting the spin-drying shaft 61 and the motor 50, power may be transmitted only to the washing shaft 62, allowing only the pulsator 37a to rotate. In response to the clutch device 63 connecting the spin-drying shaft 61 and the motor 50, power may be transmitted to both the spin-drying shaft 61 and the washing shaft 62, allowing the drum 30a and the pulsator 37a to rotate simultaneously.

When only the pulsator 37a rotates, a water current may be generated by the rotation of the pulsator 37a, and the laundry may be rotated by the generated water current and rubbed against the drum 30a, so that the laundry may be washed. When the pulsator 37a and the drum 30a rotate simultaneously, the laundry inside the drum 30a may rotate and moisture may be removed from the laundry by a centrifugal force, so that the laundry may be spin-dried.

The washing machine 10a may include a water supply device 12a. The water supply device 12a may supply water to the tub 20a. The water supply device 12a may be positioned on an upper side of the tub 20a. The water supply device 12a may include a water supply pipe and a water supply valve arranged in the water supply pipe. The water supply pipe may be connected to an external water source. The water supply pipe may extend from the external water source to a detergent supply device 90a and/or the tub 20a. Water may be supplied to the tub 20a via the detergent supply device 90a. Water may be supplied to the tub 20a without passing through the detergent supply device 90a.

The water supply valve may open or close the water supply pipe in response to an electrical signal from a controller. The water supply valve may allow or block the supply of water from the external water source to the tub 20a. The water supply valve may include, for example, a solenoid valve that opens and closes in response to an electrical signal.

The washing machine 10a may include a detergent supply device 90a configured to supply detergent to the tub 20a. The detergent supply device 90a may be configured to supply detergent into the tub 20a during a water supply process. Water supplied through the water supply pipe may be mixed with detergent via the detergent supply device 90a. The water mixed with detergent may be supplied to the interior of the tub 20a. The detergent may include laundry detergent, as well as fabric softener (i.e., dryer rinse), a deodorizer, a sanitizer, an air freshener, and the like.

The washing machine 10a may include a drainage device 80a. The drainage device 80a may be configured to discharge water received in the tub 20a to the outside. A drainage outlet 22a may be formed at a lower portion of the tub 20a for draining the water stored in the tub 20a to the outside of the tub 20a. A drainage hose 84a may be connected to the drainage outlet 22a, and a drain valve 82a for opening and closing the drainage hose 84a may be provided on the drainage hose 84a.

The washing machine 1a may provide a user interface device for interaction between a user and the washing machine 1a. The user interface device may include at least one input interface and at least one output interface.

On the other hand, in FIGS. 1 and 2, washing machines 1 and 1a are shown as examples of a clothes treating apparatus, but the present disclosure is not limited thereto. In an example, the clothes treating apparatus may be a dryer or a laundry dryer. Furthermore, the motor 50 to be described hereinafter is not limited to a clothes treating apparatus, and may be applied to various home appliances.

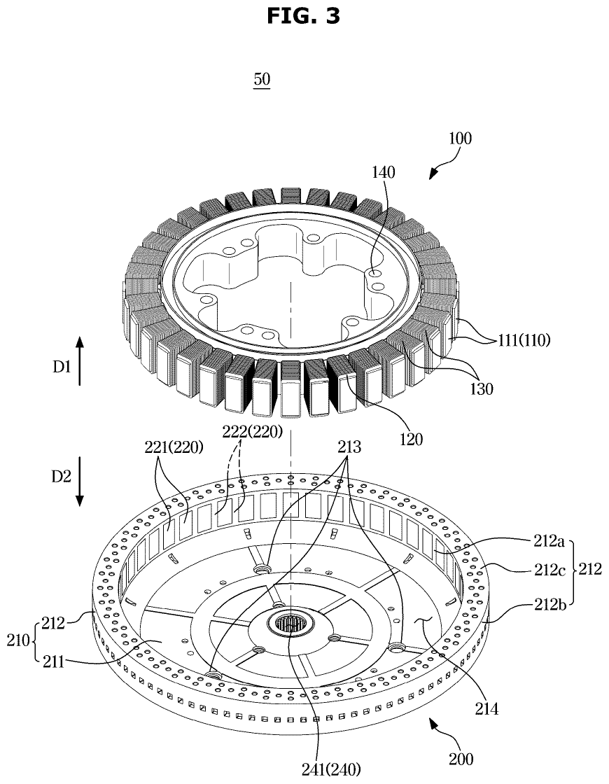

FIG. 3 illustrates a motor according to an embodiment.

The motor 50 may include a stator 100 and a rotor 200. The motor 50 may include the stator 100 and the rotor 200 rotatable relative to the stator 100. The rotor 200 may be configured to rotate by electromagnetically interacting with the stator 100. The rotor 200 may be configured to rotate outside the stator 100. The motor 50 may generate a driving force. The motor 50 may convert an electrical force into a rotational force.

The stator 100 may include a stator core 110. The stator core 110 may include a ring-shaped core body and a plurality of teeth 111 protruding radially outward from the core body. The plurality of teeth 111 may be arranged along a circumferential direction of the core body. Each of the teeth 111 may be magnetized to one of an N pole and an S pole by a magnetic field generated by the power supplied to a coil 130.

The stator 100 may include an insulator 120 configured to surround the stator core 110. The insulator 120 may be made of a material having electrical insulation properties.

The stator 100 may include the coil 130 wound on the insulator 120. The coil 130 may be wound on the insulator 120 at positions corresponding to the plurality of teeth 111. When current is supplied to the coil 130, the coil 130 may form a magnetic field.

The stator 100 may include a coupling portion 140. For example, the coupling portion 140 may include a hole into which a fastening member (not shown) (e.g., a screw) may be fastened. For example, the coupling portion 140 may be coupled to the rear of the tub 20. For example, the coupling portion 140 may be coupled to the bearing housing 21 (see FIG. 1) of the tub 20.

The rotor 200 may be arranged to surround the stator 100. The rotor 200 may include a receiving space 214 for receiving the stator 100. In an example, the motor 50 may be an outer rotor type motor configured to rotate such that the rotor 200 is positioned to surround the stator 100. An outer diameter of the stator 100 may be smaller than an inner diameter of the rotor 200. However, the present disclosure is not limited to the examples described above.

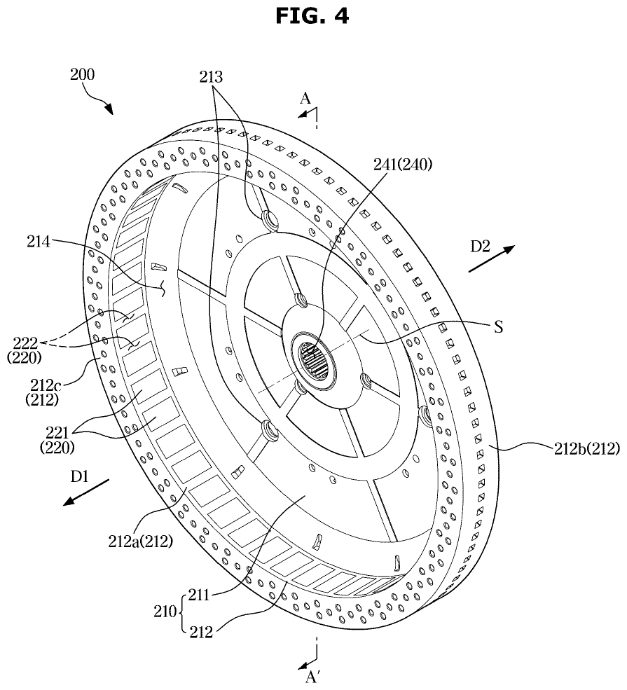

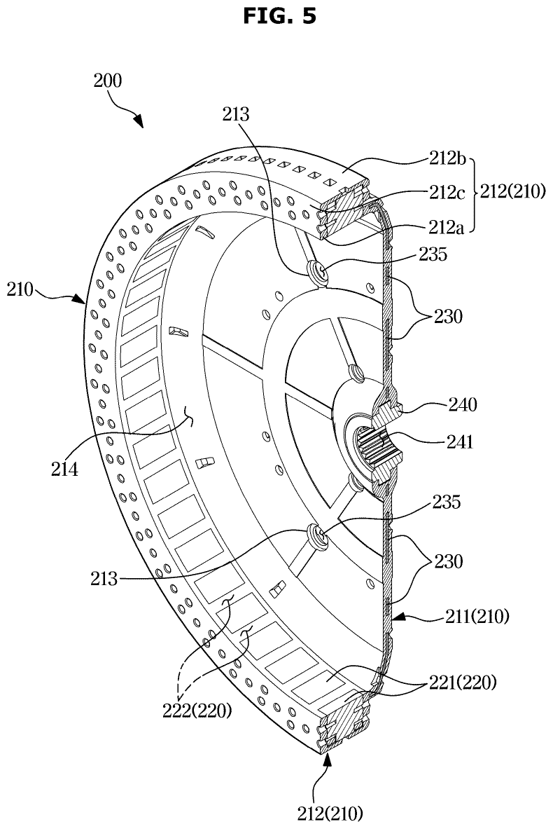

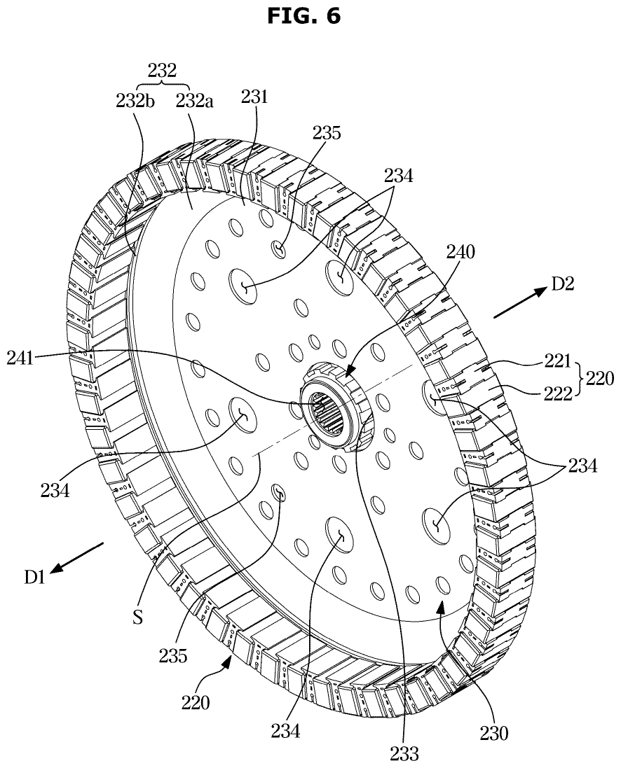

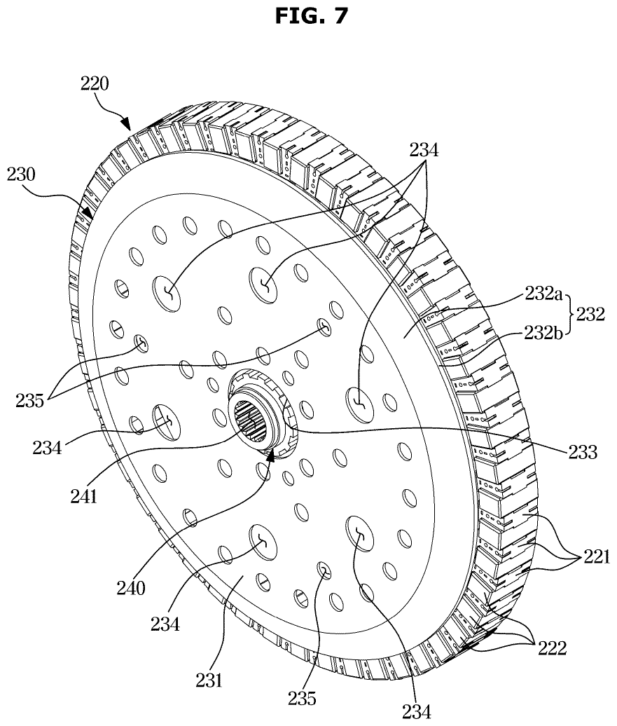

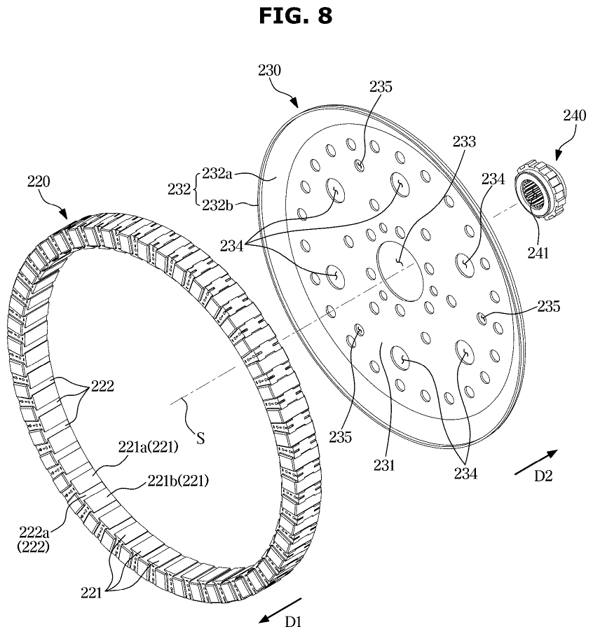

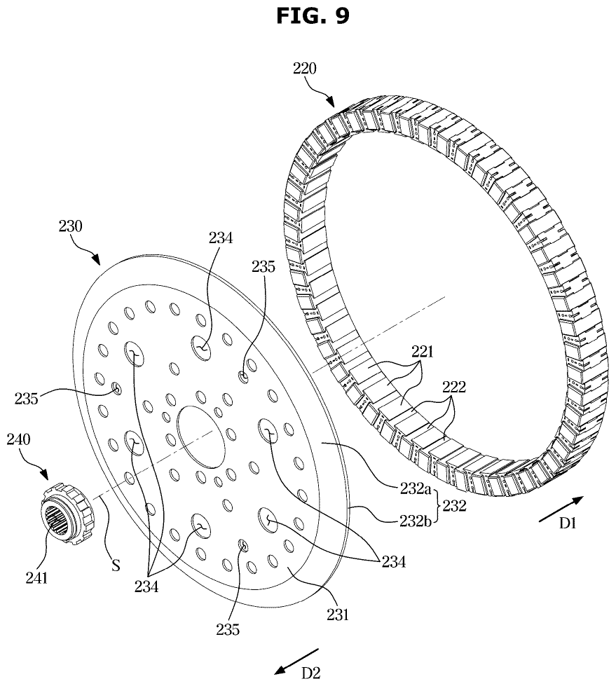

FIG. 4 is a perspective view of the rotor according to an embodiment. FIG. 5 is a cutaway perspective view taken along line A-A′ shown in FIG. 4. FIG. 6 is a perspective view of some configurations of the rotor according to an embodiment. FIG. 7 is a perspective view illustrating some configurations of the rotor according to an embodiment in a different direction from FIG. 6. FIG. 8 is an exploded view of some configurations of the rotor according to an embodiment. FIG. 9 is an exploded view illustrating some configurations of the rotor according to an embodiment in a different direction from FIG. 8.

The rotor 200 may include a holder 210. The holder 210 may form the overall appearance of the rotor 200. The holder 210 may be configured to accommodate the stator 100. The holder 210 may be configured to support and/or hold configurations of the rotor 200, such as a rotor body 220, a frame 230, and/or a bush 240.

The holder 210 may include a base 211 and a sidewall 212.

The base 211 may be configured to cover one side of the stator 100.

The sidewall 212 may be configured to surround the stator 100. The sidewall 212 may be configured to be arranged on an outer side of the stator 100. For example, the sidewall 212 may be configured to extend along a circumferential direction of the stator 100 to cover the stator 100. The sidewall 212 may extend from an edge (e.g., rim) of the base 211. The sidewall 212 may extend from the edge of the base 211 in a first direction D1. As the sidewall 212 extends from the base 211 in the first direction D1, the receiving space 214 may be formed. The sidewall 212 may be arranged to surround the stator 100. Herein, the first direction D1 may include a direction in which the motor 50 faces the drum 30 or 30a. The first direction D1 may include a direction in which the motor 50 faces the tub 20 or 20a.

The holder 210 may have a substantially cylindrical shape with one side open. The base 211 may have a substantially circular shape. The sidewall 212 may have a substantially ring shape.

The sidewall 212 may include an inner wall 212a facing an axis of rotation S of the rotor 200. The sidewall 212 may include an outer wall 212b arranged on an opposite side of the inner wall 212a. The sidewall 212 may include a connecting wall 212c connecting the inner wall 212a and the outer wall 212b.

The base 211 may be configured to correspond to the rotor body 220, which will be described later. The sidewall 212 may be configured to correspond to the frame 230, which will be described later.

The holder 210 may be formed by insert injection molding. The holder 210 may be integrally formed with the configurations of the rotor 200 through an insert injection molding process. The holder 210 may be formed by curing a molten resin. The holder 210 may be referred to as an injection mold 210. The sidewall 212 may be referred to as a first molded portion 212, and the base 211 may be referred to as a second molded portion 211. The first molded portion 212 may correspond to the rotor body 220, and the second molded portion 211 may extend from the first molded portion 212 and correspond to the frame 230. A detailed description related to the insert injection molding of the rotor 200 will be described later.

The rotor 200 may include the rotor body 220. The rotor body 220 may include a plurality of rotor cores 221 and a plurality of magnets 222. The rotor body 220 may have a substantially annular shape.

Each of the rotor cores 221 and each of the magnets 222 may be arranged alternately. Each of the rotor cores 221 and each of the magnets 222 may be alternately arranged along a rotational direction of the rotor 200. Each of the rotor cores 221 and each of the magnets 222 may be alternately arranged along a circumferential direction of the rotor 200. The plurality of rotor cores 221 may be arranged to be spaced apart along the circumferential direction of the rotor 200. The plurality of magnets 222 may be arranged to be spaced apart along the circumferential direction of the rotor 200. Each rotor core 221 may be disposed between the magnets 222. Each magnet 222 may be disposed between the rotor cores 221. For example, one magnet 222a of the plurality of magnets may be disposed between adjacent first and second rotor cores 221a and 221b of the plurality of rotor cores (see FIG. 8). Similarly, one rotor core of the plurality of rotor cores may be disposed between adjacent first and second magnets of the plurality of magnets.

The plurality of rotor cores 221 and the plurality of magnets 222 may be coupled. For example, the plurality of rotor cores 221 and the plurality of magnets 222 may be configured as an assembly.

The plurality of rotor cores 221 may be configured to support the plurality of magnets 222. The plurality of rotor cores 221 may be configured to form a magnetic path for the magnetic flux generated from the plurality of magnets 222. The plurality of rotor cores 221 may enhance the electromagnetic force generated by the electromagnetic interaction between the rotor 200 and the stator 100.

The plurality of magnets 222 may be configured to form a magnetic field. The plurality of magnets 222 may be configured to electromagnetically interact with the stator 100. The rotor 200 may rotate by interacting the magnetic field generated by the coil 130 of the stator 100 with the magnetic field generated by the plurality of magnets 222 of the rotor 200. The plurality of magnets 222 may be arranged such that the S and N poles are alternately arranged along the circumferential direction.

For example, each of the magnets 222 may include a ferrite magnet or a magnet including a rare earth element, such as neodymium or samarium. However, the present disclosure is not limited to the examples described above, and each of the magnets 220 may be provided as a magnet of a variety of materials.

The rotor body 220 may correspond to the sidewall 212 of the holder 210. The rotor body 220 may be disposed within the sidewall 212 of the holder 210. The rotor body 220 may be integrally formed with the holder 210 by means of insert injection molding.

As used herein, the meaning of a first element being “arranged inside” a second element may include at least a portion of the first element being located inside the second element. Accordingly, the meaning that the first element is “arranged inside” the second element may include not only that the entirety of the first element is completely covered by the second element, but also that a portion of the first element is exposed from the second element.

A portion of each of the rotor cores 221 may be configured to be exposed from the sidewall 212 of the holder 210. A portion of each of the rotor cores 221 may be configured to be exposed from the inner wall 212a of the holder 210. A portion of each of the rotor cores 221 may be a portion that is not covered by the holder 210. A portion of each of the rotor cores 221 may be arranged to face the axis of rotation S. Since the rotor cores 221 are exposed from the holder 210, the magnetic field formed in the magnets 222 may more easily interact with the magnetic field formed in the stator 100. The rotor cores 221 may not interfere with the electromagnetic force generated in the magnets 222.

A portion of each of the rotor cores 221 may be configured to be connected to the inner wall 212a. A surface of each of the rotor cores 221 facing the axis of rotation S may be configured to be flush with the inner wall 212a. Each of the rotor cores 221 may be connected to the inner wall 212a without a step within a predetermined error range. Accordingly, an air gap between the stator 100 and the rotor 200 may be kept constant. As the air gap between the stator 100 and the rotor 200 remains constant, vibration and/or noise of the motor 50 may be reduced and the efficiency of the motor 50 may be increased.

The rotor 200 may include the frame 230. The frame 230 may correspond to the base 211 of the holder 210. The frame 230 may be arranged inside the base 211 of the holder 210. By arranging the frame 230 inside the base 211 of the holder 210, deformation or damage to the holder 210 may be prevented. The frame 230 may be integrally formed with the holder 210 by insert injection molding, and may prevent deformation (e.g., shrinkage) or damage to the holder 210. This will be described in more detail later.

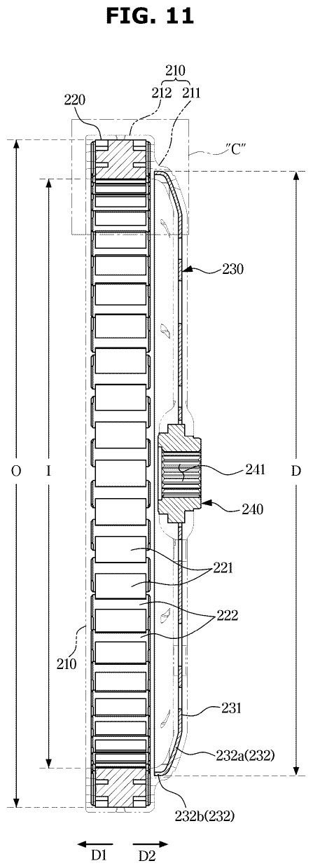

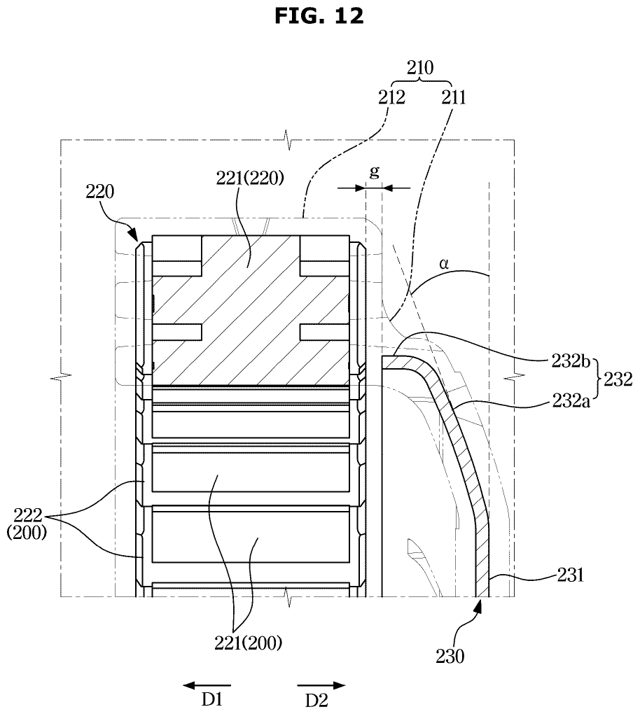

The frame 230 may be arranged to be spaced apart from the rotor body 220 (see FIGS. 11 and 12). The frame 230 may be spaced apart from the rotor body 220 in a second direction D2. The second direction D2 may be a direction opposite to the first direction D1. The frame 230 may be arranged so as not to contact the rotor body 220.

The frame 230 may include a plate 231 and a plate edge 232.

The frame 230 may include a substantially circular shape. The plate 231 may include a substantially disc shape. The plate edge 232 may include a substantially annular shape.

The plate edge 232 may be formed on an outer perimeter of the plate 231. The plate edge 232 may extend radially outward from the plate 231. The plate edge 232 may be configured to be bent toward the rotor body 220. The plate edge 232 may be configured to be bent substantially along the first direction D1. The frame 230 may include a shape in which an edge portion of the frame 230 is approximately bent inwardly. For example, the outermost portion of the plate edge 232 may be arranged not to face radially outward of the frame 230. With such a shape, the frame 230 may be arranged inside the base 211 of the holder 210 to support an edge portion of the base 211 during rotation of the rotor 200. For example, during the rotation of the rotor 200, the plate edge 232 may be subjected to a force that is opposite to a force that tends to move away from the center of rotation of the rotor 200. In other words, the frame 230 may support the holder 210 to prevent the holder 210 to be damaged by a strong centrifugal force during the rotation of the rotor 200. As a result, the rigidity of the rotor 200 may be increased.

The frame 230 may include an opening 233. The opening 233 may be formed at the center of the frame 230. The opening 233 may be formed through the plate 231 of the frame 230. The bush 240 may be disposed within the opening 233.

The frame 230 may include a first frame hole 234. The first frame hole 234 may be formed through the plate 231 of the frame 230.

As described above, the holder 210 may be formed by curing molten resin during an insert injection molding process. The molten resin may be configured to pass through the first frame hole 234 of the frame 230. The molten resin may cover the frame 230 as it passes through the first frame hole 234. The first frame hole 234 may be configured to correspond to a gate for injecting molten resin into a cavity. The first frame hole 234 may be referred to as a gate hole 234.

For example, the first frame holes 234 may be provided in a plurality, and the plurality of first frame holes 234 may be spaced apart from each other. For example, the plurality of first frame holes 234 may be arranged in a predetermined pattern.

The frame 230 may include a second frame hole 235. The second frame hole 235 may be formed through the plate 231 of the frame 230.

A fixing member (e.g., a fixing pin) for securing the rotor 200 when the rotor 200 is mounted may be inserted into the second frame hole 235. The second frame hole 235 may be referred to as a first fixing hole 235. The holder 210 may include a second fixing hole 213 configured to align with the second frame hole 235. The first fixing hole 235 and the second fixing hole 213 may communicate with each other. Upon mounting the rotor 200, a fixing member may be inserted into the first fixing hole 235 and the second fixing hole 213 to secure the rotor 200.

For example, the second frame holes 235 may be provided in a plurality, and the plurality of second frame holes 235 may be spaced apart from each other. For example, the plurality of second frame holes 235 may be arranged in a predetermined pattern.

The rotor 200 may include the bush 240. The bush 240 may be disposed in the opening 233 of the frame 230. The bush 240 may be configured to form the axis of rotation S of the rotor 200. The center of the bush 240 may form the axis of rotation S. The bush 240 may transmit the rotational force generated by the rotor 200 to the rotating shaft 60. The bush 240 may be coupled to the rotating shaft 60 (see FIGS. 1 and 2). The bush 240 may include a bush hole 241 into which the rotating shaft 60 may be inserted. For example, a serration may be formed on an inside of the bush hole 241.

The bush 240 may be integrally formed with the holder 210 by insert injection molding. The bush 240 may be secured to the base 211 of the holder 210.

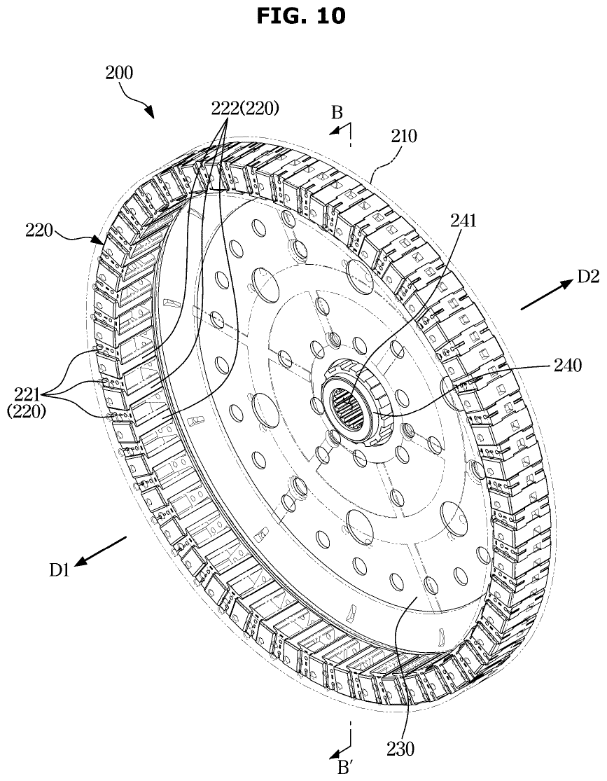

FIG. 10 illustrates the interior of the rotor according to an embodiment. FIG. 11 is a cross-sectional view taken along line B-B′ shown in FIG. 10. FIG. 12 is an enlarged view of portion C shown in FIG. 11.

Referring to FIG. 10, the rotor 200 may include the rotor body 220, the frame 230, and the bush 240. More specifically, in FIG. 10, in order to show how the framer 230 is arranged inside the base 211 of the holder 210, the base 211 is depicted with dash-double-dot lines (for example, the base 211 is depicted transparently), and the frame 230 arranged inside the base 211 is depicted with solid line.

The rotor 200 may include the holder 210. The holder 210 may support the rotor body 220, the frame 230, and the bush 240. The holder 210 may hold the rotor body 220, the frame 230, and the bush 240. The holder 210 may be configured to cover the rotor body 220, the frame 230, and the bush 240.

The rotor 200 may be manufactured using an insert injection molding process. The holder 210, the rotor body 220, and the frame 230 may be integrally formed by insert injection molding. The holder 210, the rotor body 220, the frame 230, and the bush 240 may be integrally formed by insert injection molding.

For example, the rotor body 220, the frame 230, and the bush 240 may be disposed within a cavity of a mold. Molten resin may be injected into the cavity of the mold through a gate. Once injected into the cavity, the resin may be filled around the rotor body 220, the frame 230, and the bush 240. In this case, the resin may be configured to cover the frame 230 while passing through the first frame holes 234 of the frame 230. The resin filled in the cavity may be cooled and cured. The cured resin may form the holder 210. The holder 210 may be integrally formed with the rotor body 220, the frame 230, and/or the bush 240 by insert injection molding. The base 211 of the holder 210 may be integrally formed with the frame 230 and the bush 240. The base 211 of the holder 210 may support and/or hold the frame 230 and the bush 240. The sidewall 212 of the holder 210 may be integrally formed with the rotor body 220. The sidewall 212 of the holder 210 may support and/or hold the rotor body 220.

Generally, when a rotor is manufactured using an insert injection molding process, an injection molded product constituting the rotor may be deformed. In an example, if the thickness of the injection molded product is not constant and varies considerably, or if the thickness of the injection molded product is thick, the injection molded product may shrink as it cools. When the injection molded product shrinks, the magnetic field of the rotor may become unstable as the dimensions of the rotor change. In an example, as the rotor rotates, a strong centrifugal force may be generated, causing the plurality of magnets and the plurality of rotor cores to attempt to be ejected from the injection molded product and the injection molded product to be deformed or damaged. To prevent the injection molded product from scattering and to increase the strength, a ring member press-fitted to an outer side of the injection molded product may be additionally provided. However, the ring member may be made of a relatively expensive non-magnetic steel use stainless (SUS) material to prevent magnetic flux leakage. After the insert injection molding process, a process of press-fitting the ring member to the outer side of the injection molded product may be additionally required. This may increase the manufacturing cost of the rotor and reduce the process efficiency of the roto. Furthermore, as the ring member is press-fitted to the outer side of the injection molded product, the outer diameter of the rotor may increase.

In contrast, according to an embodiment of the present disclosure, the rotor 200 may include the frame 230. The frame 230 may be configured to prevent deformation or damage to the holder 210. The frame 230 may be configured to prevent scattering of the holder 210. The frame 230 may be configured to increase the rigidity of the rotor 200.

For example, the frame 230 may include a material having a strength greater than the strength of the resin. For example, the frame 230 may include a material having a coefficient of thermal expansion less than the coefficient of thermal expansion of the resin. For example, the frame 230 may include a metallic material.

The frame 230 may be disposed inside the base 211 of the holder 210. The frame 230 may be integrally formed with the holder 210 by an insert injection molding process. The resin may cover the frame 230 and then be cured and cooled to form the holder 210. The frame 230 may support the holder 210 while forming a kind of skeleton inside the holder 210. Accordingly, the holder 210 may not be deformed by the frame 230. The holder 210 may be prevented from shrinking after the insert injection molding process by the frame 230.

The frame 230 may be disposed inside the base 211 and configured to support the edge of the base 211 connected to the sidewall 212. The frame 230 may have a shape in which the edge portion of the frame 230 is bent. In other words, the frame 230 may include the plate edge 232. The plate edge 232 may be bent toward the rotor body 220. In general, the edge portion of the rotor may be subjected to the greatest centrifugal force during the rotation of the rotor, which may cause damage (e.g., cracking) to the injection molded product constituting the rotor. According to the present disclosure, the plate edge 232 of the frame 230 may be configured to correspond to the edge portion of the base 211 of the holder 210. The plate edge 232 of the frame 230 may be configured to support a portion of the base 211 connected to the sidewall 212. By having the plate edge 232, the frame 230 may be configured to be bent inwardly at approximately the outer edge portion, and accordingly, a force opposite to the force that tends to move away from the center of rotation during the rotation of the rotor 200 may act on the plate edge 232. In other words, the plate edge 232 of the frame 230 may be disposed inside the base 211 of the holder 210 to reduce/offset the force that tends to move away from the center of rotation of the rotor 200. Accordingly, even when a strong centrifugal force is generated during the rotation of the rotor 200, the holder 210 may not be damaged by the frame 230. As a result, the frame 230 may help to ensure the rigidity of the rotor 200.

The rotor 200 may not include the ring member. The process of press-fitting the ring member to the injection molded product may be eliminated. The frame 230 may be made of a metallic material that is relatively cheaper than the material of the ring member. As a result, the manufacturing cost of the rotor 200 may be reduced, and the manufacturing efficiency of the rotor 200 may be increased. Furthermore, the ring member may not be press-fitted to the outer side of the holder 210, which may not increase the outer diameter of the rotor 200.

Referring to FIG. 11, a diameter D of the frame 230 according to an embodiment may be smaller than an outer diameter O of the rotor body 220 and larger than an inner diameter I of the rotor body 220. The outer diameter O of the rotor body 220 may refer to a diameter of the outermost edge of the rotor body 220. The inner diameter I of the rotor body 220 may refer to a diameter of the innermost edge of the rotor body 220. The edge of the frame 230 may be configured to correspond between the outermost edge of the rotor body 220 and the innermost edge of the rotor body 220. In this case, the frame 230 and the rotor body 220 may be concentric. The center of the frame 230 and the center of the rotor body 220 may be on the same line as the axis of rotation S.

For example, when the diameter D of the frame 230 is larger than the outer diameter O of the rotor body 220, the area where the frame 230 and the rotor body 220 overlap becomes larger, and the frame 230 may affect the magnetic field formed in the rotor body 220. For example, when the diameter D of the frame 230 is larger than the outer diameter O of the rotor body 220, the frame 230 may weaken the magnetism of the plurality of magnets 230. For example, when the diameter D of the frame 230 is larger than the outer diameter O of the rotor body 220, the size and weight of the rotor 200 may increase. For example, when the diameter D of the frame 230 is smaller than the inner diameter I of the rotor body 220, the effectiveness of the frame 230 in reinforcing the rigidity of the holder 210 may be reduced. Accordingly, to ensure that the frame 230 does not affect the magnetic field of the rotor body 220 while supporting the holder 210, the diameter D of the frame 230 may be smaller than the outer diameter O of the rotor body 220 and larger than the inner diameter I of the rotor body 220.

Referring to FIG. 12, the frame 230 according to an embodiment may include the plate 231 and the plate edge 232.

For example, the plate edge 232 may include a first extension 232a. The first extension 232a may be bent from an edge of the plate 231 and formed to be inclined with respect to the plate 231. The first extension 232a may be bent from the plate 231 toward the rotor body 220. The first extension 232a may be bent from the plate 231 in the first direction D1. The first extension 232a may include a shape that tapers as it moves away from the rotor body 220. The first extension 232a may be configured to taper along the second direction D2. An inclination angle a between the plate 231 and the first extension 232a may be approximately 10 degrees or more.

For example, the plate edge 232 may include a second extension 232b. The second extension 232b may be bent from the edge of the first extension 232a and extend toward the rotor body 220. The second extension 232b may extend from the first extension 232a in the first direction D1.

For example, each of the bent portions of the plate edge 232 may have a radius of curvature of approximately 2 mm or more.

However, the present disclosure is not limited to the examples described above, and there is no limitation on the shape of the plate edge 232 as long as the plate edge 232 includes at least one bent portion toward the rotor body 220.

Referring to FIG. 12, the frame 230 according to an embodiment may be spaced apart from the rotor body 220 along the second direction D2. A gap g may be formed between the frame 230 and the rotor body 220.

For example, when gap g is not formed between the frame 230 and the rotor body 220 or when the gap g is very small, the frame 230 may affect the magnetic field formed in the rotor body 220. For example, when the gap g is not formed between the frame 230 and the rotor body 220 or when the gap g is very small, the frame 230 may demagnetize the plurality of magnets 230. To prevent such a situation, the frame 230 and the rotor body 220 may be configured not to contact each other. In an example, a resin (i.e., the material of the holder 210) may be filled between the frame 230 and the rotor body 220.

For example, when the gap g between the frame 230 and the rotor body 220 is very large, the size and weight of the rotor 200 may increase. Accordingly, the frame 230 and the rotor body 220 may be spaced apart within a predetermined range.

For example, the gap g may be about 0.5 mm or more and about 10 mm or less. However, the numerical ranges described above are merely examples, and the present disclosure is not limited thereto. The numerical range of the gap g may vary depending on the type of the rotor 200, the size of each configuration of the rotor 200, the material of each configuration of the rotor 200, and the like.

The motor 50 according to an embodiment of the present disclosure may include the stator 100 and the rotor 200 configured to rotate outside the stator 100. The rotor 200 may include the holder 210 configured to accommodate the stator 100. The holder 210 may include the base 211 and the sidewall 212. The base 211 may be configured to cover one side of the stator 100. The sidewall 212 may be configured to extend from the edge of the base 211 and configured to surround the stator 100. The rotor 200 may include the rotor body 220 including the plurality of rotor cores 221 and the plurality of magnets 222. Each of the rotor cores 221 and each of the magnets 222 may be configured to be arranged alternately. The rotor body 220 may be arranged inside the sidewall 212. The rotor 200 may include the frame 230 arranged inside the base 211. The frame 230 may be configured to support the edge of the base 211 connected to the sidewall 212.

The holder 210, the rotor body 220, and the frame 230 may be integrally formed by insert injection molding.

The rotor body 220 may include an annular shape. The frame 230 may include a circular shape.

The sidewall 212 may extend from the edge of the base 211 in the first direction D1. The frame 230 may be spaced apart from the rotor body 220 in the second direction D2 opposite to the first direction D1.

The diameter D of the frame 230 may be smaller than the outer diameter O of the rotor body 220. The diameter D of the frame 230 may be larger than the inner diameter I of the rotor body 220.

The frame 230 may include the plate 231 and the plate edge 232. The plate edge 232 may extend radially outwardly from the plate 231 and be configured to be bent toward the rotor body 220.

The plate edge 232 may include the extension 232a bent from the edge of the plate and formed to be inclined with respect to the plate. The extension 232a may include a shape that tapers in a direction away from the rotor body 220.

The extension 232a may be the first extension 232a. The plate edge 232 may further include the second extension 232b bent from the edge of the first extension 232a and extending toward the rotor body 220.

The frame 230 may include the opening 233 formed at the center of the frame 230. The rotor 200 may further include the bush 240 configured to be disposed inside the opening 233 of the frame 230. The bush 240 may be configured to form the axis of rotation S of the rotor 200.

The rotor body 220, the frame 230, the bush 240, and the holder 210 may be integrally formed by insert injection molding.

The holder 210 may be formed by curing of a molten resin.

The frame 230 may include the gate hole 234 configured to allow the molten resin to pass through.

The frame 230 may include the first fixing hole 235, and the holder 210 may include the second fixing hole 213 arranged to overlap with the first fixing hole 235.

The frame 230 may include a metallic material.

The sidewall 212 of the holder 210 may include the inner wall 212a facing the axis of rotation S of the rotor 200, the outer wall 212b arranged on an opposite side of the inner wall, and the connecting wall 212c connecting the inner wall and the outer wall. A portion of each of the rotor cores 221 may be exposed from the inner wall 212a and configured to be connected to the inner wall 212a.

The clothes treating apparatus 1 or 1a according to an embodiment of the present disclosure may include the tub 20 or 20a, the drum 30 or 30a rotatable in the tub, the motor 50 configured to generate a driving force, the motor 50 including the stator 100 and the rotor 200 configured to rotate in interaction with the stator 100, and the rotating shaft 60 configured to connect the motor 50 and the drum 30 or 30a to transmit the driving force of the motor 50 to the drum 30 or 30a. The rotor 200 may include the rotor body 220 including the plurality of rotor cores 221 and the plurality of magnets 222. Each rotor core 221 and each magnet 222 of the rotor body 220 may be configured to be alternately arranged along the rotational direction of the rotor 200. The rotor body 220 may have an annular shape. The rotor 200 may include the frame 230 spaced apart from the rotor body 220 and having a circular shape. The rotor 200 may include the holder 210 integrally formed with the rotor body 220 and the frame 230 by insert injection. The holder 210 may include the first molded portion 212 corresponding to the rotor body 220. The holder 210 may include the second molded portion 211 extending from the first molded portion 212 and corresponding to the frame 230.

The frame 230 may include the plate 231 and the plate edge 232 extending radially outwardly from the plate 231 and configured to be bent toward the rotor body 220.

The plate edge 232 may include the first extension 232a bent from the edge of the plate 231 and formed to be inclined with respect to the plate 231 and including a shape that tapers in a direction away from the rotor body 220, and the second extension 232b bent from the edge of the first extension 232a and extending toward the rotor body 220.

The first molded portion 212 may extend from the edge of the second molded portion 211 in the first direction D1. The frame 230 may be spaced apart from the rotor body 220 in the second direction D2 opposite to the first direction D1.

The diameter D of the frame 230 may be less than the outer diameter O of the rotor body 220 and greater than the inner diameter I of the rotor body 220.

According to the idea of the present disclosure, the motor 50 may include the rotor 200 having an improved structure. The motor 50, which is applied to the clothes treating apparatus 1 or 1a and other home appliances, may include the rotor 200 having an improved structure.

According to the spirit of the present disclosure, the rotor 200 may include the frame 230. The holder 210 and the frame 230 may be integrally formed by insert injection molding. The frame 230 may be configured to prevent deformation (e.g., shrinkage) and/or damage to the holder 210. The frame 230 may increase the strength of the holder 210. Accordingly, the lifespan of the rotor 200 may be increased.

According to the spirit of the present disclosure, the manufacturing efficiency of the rotor 200 may be increased. The rotor 200 does may eliminate the ring member. Accordingly, the manufacturing process of the rotor 200 may be simplified, and the manufacturing cost of the rotor 200 may be reduced.

The effects to be obtained from the present disclosure are not limited to those mentioned above, and other effects not mentioned will be apparent to those having ordinary skill in the art to which the present disclosure pertains from the following description.

Although specific embodiments have been illustrated and described above, the present invention is not limited to the above-described embodiments, and those of ordinary skill in the art to which the invention pertains will be able to make various modifications and changes without departing from the gist of the technical idea of the invention described in the claims below.

What is claimed is:

1. A motor, comprising:
a stator; and
a rotor configured to rotate relative to the stator and outside the stator;
wherein the rotor comprises:
a holder configured to accommodate the stator, the holder including:
a base configured to cover one side of the stator; and
a sidewall extending from an edge of the base and configured to surround the stator;
a rotor body disposed inside the sidewall, the rotor body including:
a plurality of rotor cores; and
a plurality of magnets and configured so that each of the plurality of rotor cores and each of the plurality of magnets are arranged alternately; and
a frame disposed inside the base to support the edge of the base connected to the sidewall.

2. The motor of claim 1, wherein the holder, the rotor body, and the frame are integrally formed by insert injection molding.

3. The motor of claim 1, wherein the rotor body comprises a ring shape, and the frame comprises a circular shape.

4. The motor of claim 1, wherein the sidewall extends from the edge of the base in a first direction, and
the frame is spaced apart from the rotor body in a second direction which is a direction opposite to the first direction.

5. The motor of claim 3, wherein a diameter of the frame is smaller than an outer diameter of the rotor body and larger than an inner diameter of the rotor body.

6. The motor of claim 3, wherein the frame comprises:
a plate; and
a plate edge extending radially outward from the plate, and configured to be bent toward the rotor body.

7. The motor of claim 6, wherein the plate edge comprises an extension bent from an edge of the plate, configured to be inclined with respect to the plate, and including a shape that tapers in a direction away from the rotor body.

8. The motor of claim 7, wherein
the extension is a first extension, and
the plate edge further comprises a second extension bent from an edge of the first extension and extending toward the rotor body.

9. The motor of claim 1, wherein
the frame comprises an opening formed at a center of the frame, and
the rotor further comprises a bush disposed inside the opening of the frame and configured to form an axis of rotation of the rotor.

10. The motor of claim 9, wherein the rotor body, the frame, the bush, and the holder are integrally formed by insert injection molding.

11. The motor of claim 2, wherein the holder is formed by curing a molten resin.

12. The motor of claim 11, wherein the frame comprises a gate hole configured to allow the molten resin to pass through.

13. The motor of claim 1, wherein
the frame comprises a first fixing hole, and
the holder comprises a second fixing hole arranged to overlap with the first fixing hole.

14. The motor of claim 1, wherein the frame comprises a metallic material.

15. The motor of claim 1, wherein
the sidewall of the holder comprises:
an inner wall facing an axis of rotation of the rotor;
an outer wall arranged on an opposite side of the inner wall; and
a connecting wall connecting the inner wall and the outer wall, and
a portion of each of the rotor cores is exposed from the inner wall and configured to be connected to the inner wall.

16. The motor of claim 4, wherein the rotor further comprises a gap formed between the frame and the rotor body so that the frame does not to contact with the rotor body.

17. The motor of claim 16, wherein the gap is about 0.5 mm or more and about 10 mm or less.

18. The motor of claim 1, wherein the holder is formed by a cured molten resin, and the rotor body, and the cured molten resin covers the frame.

19. The motor of claim 18, wherein the frame has a material having a coefficient of thermal expansion less than the coefficient of thermal expansion of the cured molten resin so that the frame includes the material having a strength greater than a strength of the cured molten resin.
